(19) United States
(12) Patent Application Publication
(10) Pub. No.: US 2013/0232729 A1
(43) Pub. Date: Sep. 12, 2013

(54) MULTIELEMENT MAGNETIC CLOSURE

(71) Applicant: Joseph ABADI, Brooklyn, NY (US)

(72) Inventor: Joseph ABADI, Brooklyn, NY (US)

(21) Appl. No.: 13/414,047

(22) Filed: Mar. 7, 2012

(51) Int. Cl. H01F 7/02; A44B 6/00; A44B 5/00; A44B 99/00

(52) U.S. Cl. 24/66.4; 24/299; 24/303

(57) ABSTRACT

A clasp, including a first magnet, a second magnet, and a third magnet wherein the clasp is closed by coupling the three magnet in an aligned configuration and is opened by uncoupling at least two of the three magnets.

### BACKGROUND OF THE INVENTION

A. Field of the Invention

The present invention relates to a closure suited for fastening portions of clothing article such as a tie, the closure includes several magnetic elements aligned in operation and attracting each other to define one or more press nips grasping the portions of the clothing article.

B. Description of the Prior Art

A traditional tie pin or clip prevents the tie of the wearer of the tie pin from slipping to awkward angles while allowing the tie a degree of mobility. In addition, the traditional alligator/clasp tie clip embellishes the visual appeal of the tie. However, one traditional tie pin includes a pin that pierces through the tie leaving a hole each time that it is used, damaging the tie and adversely impacting its appearance. A traditional alligator/clasp tie clip does not damage a tie; however, it suffers from the disadvantages of being bulky, rendering the tie completely immobile at the point of attachment of the tie clip, and being less attractive in the opinion of many tie wearers. It would therefore be desirable to provide a tie pin that did not damage a tie.

In my U.S. Pat. No. 7,992,264 I have improved on the traditional tie pin somewhat; however, there was still room for improvement. In the present invention, I have overcome some of the disadvantages of the prior art closure devices as discussed in more detail below.

### SUMMARY OF THE INVENTION

A clasp, including a first magnet, a second magnet and a third magnet cooperating to form two or more magnetic fields wherein the clasp is closed and opened by coupling or uncoupling the magnets.

### BRIEF DESCRIPTION OF THE DRAWINGS

FIG. 1 is a first prior art magnetic closure;

FIG. 2 is a second prior art magnetic closure;

FIG. 3 shows a first embodiment of the present invention;

FIGS. 4 and 4A show another embodiment;

FIGS. 5-5C show another embodiment;

FIG. 6 shows another embodiment;

FIGS. 7, 7A and 7B show another embodiment; and

FIGS. 8, 8A and 8B show another embodiment.

### DETAILED DESCRIPTION OF THE PREFERRED EMBODIMENTS

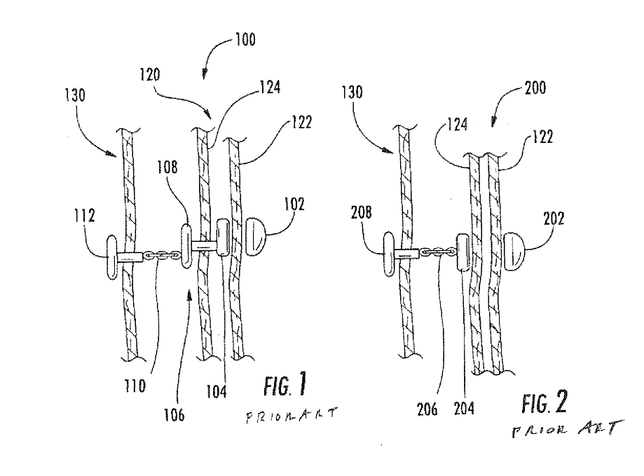

Referring to FIG. 1, a tie pin 100 disclosed in U.S. Pat. No. 7,992,264 includes outer magnet 102, inner magnet 104, piercing pin 106, pin base 108, chain 110, and T-shaped end 112. Piercing pin 106 is attached to pin base 108, which is constructed of the same material as piercing pin 106 and can form a “T” shape in combination with piercing pin 106. Chain 110 can be a metal chain constructed of brass, aluminum, stainless steel, precious metals (gold, silver, platinum, etc.), or can be constructed of other materials and is attached to both pin base 108 and T-shaped end 112. T-shaped end 112 can be constructed of brass, aluminum, or stainless steel, precious metals, or can be constructed of other materials. Also illustrated in FIG. 1 is tie 120 comprised of front end 122 and rear end 124 and shirt 130. Tie 120 can be any available necktie, whether made of silk, wool, synthetic, or other materials, or a combination of materials. Shirt 130 can be any shirt, such as a men's dress shirt, whether made of silk, cotton, synthetic, or other materials, or a combination of materials. Shirt 130 can, but need not, be a button down shirt.

In one embodiment, T-shaped end 112 is placed with the cross-piece of the “T” inside a wearer's shirt button hole with the end of the “T” protruding, together with chain 110, which is attached to T-shaped end 112. Piercing pin 106, attached to pin base 108, attached in turn to chain 110, is placed through tie rear end 124 and attached to inner magnet 104, such as by screwing piercing pin 106 into inner magnet 104, sliding piercing pin 106 into a groove in inner magnet 104, or by other means. Tie front end 122 is then placed in front of inner magnet 104 and finally outer magnet 102 is placed in front of tie front end 122 so as to couple outer magnet 102 with inner magnet 104.

Outer magnet 102 and inner magnet 104 when coupled together hold tie front end 122 in place without creating any unsightly holes in tie front end 122. Outer magnet 104, piercing pin 106, and pin base 108 together hold tie rear end 124; although a hole is created in tie rear end 124 by piercing pin 106, such hole is not visible when the tie is worn because tie rear end 124 is concealed behind tie front end 122. Pin base 108, chain 110, and T-shaped end 112 together form a connection to the wearer's shirt.

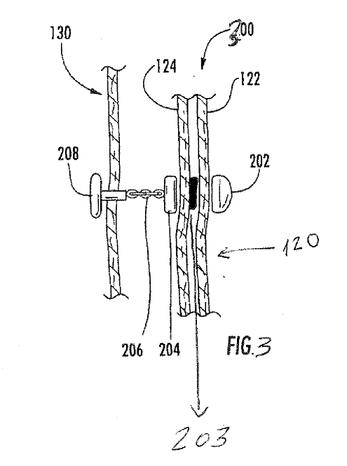

Referring to FIG. 2, in another embodiment disclosed in U.S. Pat. No. 7,992,264, tie pin 200 includes outer magnet 202, inner magnet 204, chain 206, and T-shaped end 208.

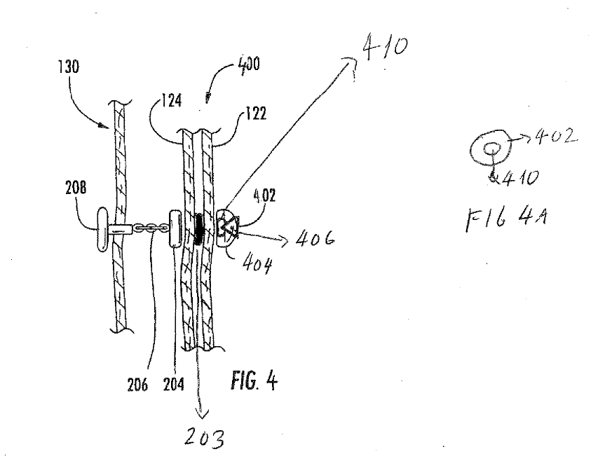

In the present invention, shown in FIG. 3 a tie pin 300 is provided that has been modified to include an intermediate magnet 203. Outer magnet 202, intermediate magnet 203 and inner magnet 204 are preferably strong magnets made of rare earths and similar materials in order to allow the outer magnet 202, intermediate magnet 203 and inner magnet 204 to be of sufficiently small size.

Outer magnet 202, intermediate magnet 203 and inner magnet 204 may be surrounded by housings constructed of metal, plastic, or other materials, which can be decorative in nature. However in some embodiments, no housing is provided, as described more fully below. One or more of such housings can include one or more decorative surfaces. Alternatively, or in addition, one or more of such housings can be shaped into a decorative form. Chain 206 can be a metal chain constructed of brass, aluminum, or stainless steel, precious metals, or can be constructed of other materials and is attached to both inner magnet 204 and T-shaped end 208. T-shaped end 208 can be constructed of brass, aluminum, stainless steel, precious metals or can be constructed of other materials. Also illustrated in FIG. 3 is tie 120, comprised of front end 122 and rear end 124 and shirt 130. Tie 120 can be any available necktie, whether made of silk, wool, synthetic, or other materials, or a combination of materials. Shirt 130 can be any shirt, such as a men's dress shirt, whether made of silk, cotton, synthetic, or other materials, or a combination of materials. Shirt 130 can, but need not, be a button down shirt.

The tie pin 300 is used by inserting pin 208 through a button hole in shirt 130 and then positioning the three magnets so they are generally coaxial with the rear end 124 disposed between a press nip formed between the inner magnet 204 and intermediate magnet 203 and the front end 122 being disposed between a second press nip formed between intermediate magnet 203 and front magnet 202. In the previous embodiments shown in U.S. Pat. No. 7,992,264 and reproduced in FIG. 1, a hole has to be made in the rear end 124. In the embodiment of FIG. 2, both ends of the tie must be secured between the rear and front magnets. That means that either the magnets have to be made very thick and large to generate the necessary magnetic force, or the tie pin can be used only for very thin tie, since as is well known, the force generated between two magnets falls exponentially with distance. In the present invention, the need for puncturing the rear tie end and the need for extra magnets or the requirement for a thin tie is eliminated by using the intermediate magnet 203.

Importantly, in the embodiment of FIG. 3, the magnets have to be aligned with opposite polls being matched in the sequence N-S, N-S, N-S otherwise they would repel each other and would not work.

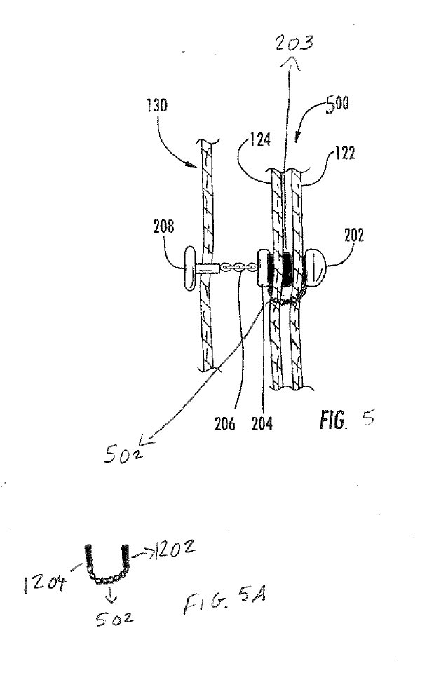

FIGS. 4 and 4A show another embodiment similar to the embodiment of FIG. 3, but with outer magnet 402 having a toroidal shape with an internal hole 410. The outer magnet 402 is disposed in outer housing 404 and is sized and shaped to receive a diamond or other precious or semiprecious stone having a tip that extends into the internal hole 410.

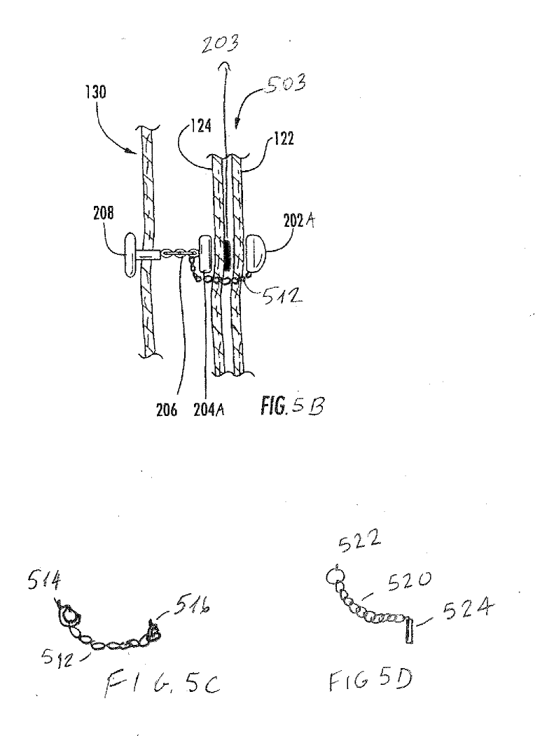

FIGS. 5 and 5A show another embodiment of the invention. In this embodiment, a tie pin is presented that includes a pin 208, chain 206, an inner main magnet 204, an intermediate magnet 203 and an outer magnet 202. In addition, a separate another intermediate element is provided, that as best seen in FIG. 5A, includes a second chain 502 connected to two thin, disk shaped magnets, inner auxiliary magnet 1204 and outer auxiliary magnet 1202. In use, the chain, 502 (shown somewhat diagrammatically) is long enough so that it laterally wraps around the tie ends 122, 124. The auxiliary magnets 1204, 1202 are optionally attached to the respective magnets 204, 203. The chain 502 in this configuration can be decorative and it may be provided in different shapes and colors, and can be constructed of brass, aluminum, stainless steel, precious metals, or can be constructed of other materials. The user has the option of using the chain (for extra security or aesthetic reasons) or not, according to the user's preference.

FIGS. 5B and 5C show a variation 503 of the embodiment of FIGS. 5, 5A. In this embodiment chain 512 includes two ends 514, 516. End 514 is attached to the chain 206 (or, alternatively to element 204A) and end 516 is attached to the outer magnet 202A. The ends 514, 516 include conventional locking mechanisms, well known in the jewelry field, for being removable while being able to attach either two chains together end-to-end, or to attach the end of a chain to another article. As in the embodiment of FIGS. 5, 5A, the user has the option of using the chain 512 or not by attaching and detaching its ends 514, 516 to chain 206 (or element 204) and magnet 202A, respectively. In either variations of the invention, but especially in the second variation just described, the chains 502, 512 further ensure the security of magnet 202A which has a design, of which it may have an integral or semiprecious stone, as described above in conjunction with FIG. 4.

FIG. 5D shows another variation. In this variation, the tie pin 500 includes a chain 520 having one end 522 with a conventional lock (as described above) and a second end 524 formed of a flat, generally circular magnet. The user can have the option of attaching chain 520 in a manner similar to 5A or 5C to the rest of the tie pin, or can leave the chain 520 off.

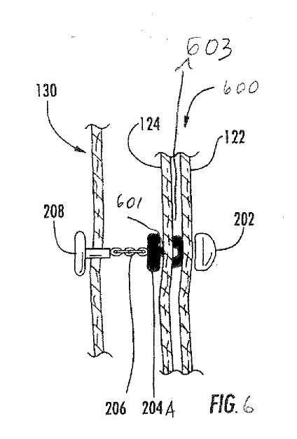

FIG. 6 shows another embodiment. In this embodiment, inner magnet 204A is convex with an axial protrusion 601 directed outwardly as shown and intermediate magnet 603 is concave to accept the protrusion 601.

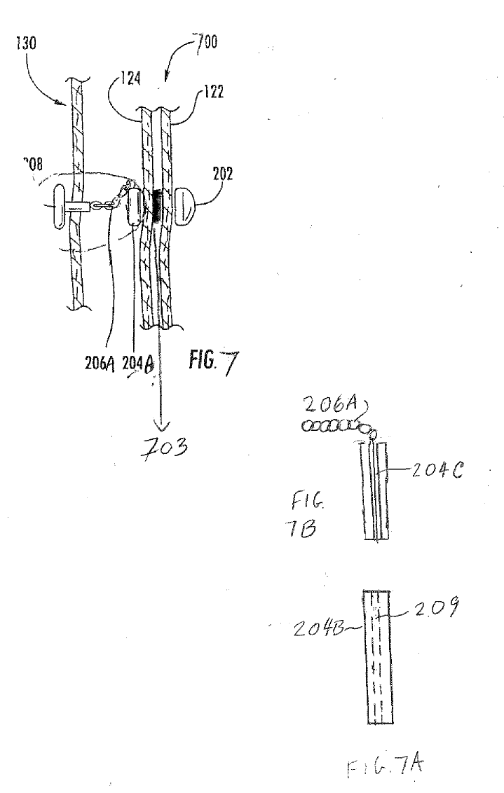

FIGS. 7, 7A and 7B show another 700 embodiment of the invention. In the previous embodiments, it was contemplated that each or some of the magnets are enclosed in a housing that surround the magnet(s) all around, or at least along one of the major surfaces. A possible problem with this approach is that magnets are visually identical and therefore during assembly it is difficult to ensure that each magnet's pole orientation is properly inserted. However if the magnets are not oriented properly within the housing, but one of them is reversed, then the closure would not work because the magnets could not be aligned in a N-S/N-S/N-S (or S-N/S-N/S-N) pattern. In order to solve this problem, in FIGS. 7, 7A, 7B one or more of the magnets are provided with a through hole 209. Then instead of a housing, a rod 204C is pushed through the magnet (e.g. magnet 204B) and one end of the rod 204C is secured to some other member for securing the magnet, such as chain 206A. Rod 204C can be attached to magnet 204B using a glue or other adhesive, or by sizing it and/or the hole 209 to create an interference fit between the rod 204C and magnet 204B. In yet another variation, a ring can be provided that fits around the circumferential diameter of the magnet 204B to strengthen the same. The rod 204C is then attached to the ring. In yet another variation, hole 209 and rod 204C extend only partially into the magnet. In yet another embodiment of the invention, a ring (not shown) is provided around the magnet and attached to the chain in a manner that allows the magnet to free rotate with respect to the chain to present either one face, or the other toward the other magnet.

These configurations allow the user to reverse the orientation of the magnet 204B so that it will engage with, and form an interference/attraction fit with the next magnet (e.g. 703).

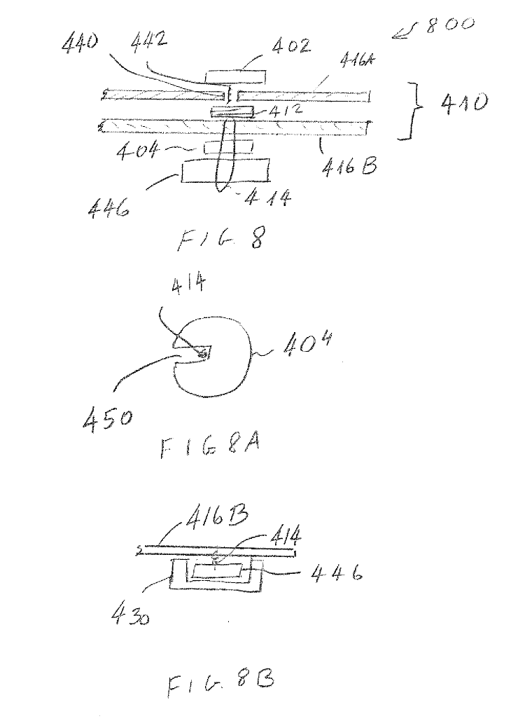

The closure 800 of FIGS. 8A, 8B, 8C show an embodiment used to connect the cuffs of a dress shirt 410. More particularly, the closure 800 is used to attach the cuffs of a regular shirt to make it look like a french cuff. Shirt 410 has two layers 416A, 416B overlapping to form a common edge. Layer 416A has a slit or opening 440 and layer 416B has a standard button 446 attached to the layer 416B by a thread 414 formed into loops (or other similar means).

Normally, the layers 416A, 416B overlap in the opposite direction so that button 446 can pass through a conventional button hole or slit 440. However, in the presented configuration the user wishes to use his conventional shirt (this may be due for financial reasons, or other reasons) and give it the look of a french cufflink shirt, for this reason closure 800 is provided to join the two layers in a decorative manner. The closure 800 includes an outer element 402 that may or may not be magnetic and a magnet 412 is linked with a chain 442 to element 402, the chain 442 passes through the conventional button hole 440. The closure 800 further includes an inner magnet 404 disposed between the layer 416B and button 446 in a manner that allows the magnet 412 to be inserted into the position shown in FIG. 8 or removed at will. For example, the inner magnet 404 may be circular with a slit 450 receiving thread 414 as shown.

When the two magnets 412, 404 are placed as shown in FIG. 8. The magnet 412 is attracted/links to the inner magnet 404 thereby securing and holding the layers 416A, 416B together.

In the alternative embodiment of FIG. 8B, a larger magnet 430 is used, said magnet 430 having an inner cavity for housing and hiding button 446 on the inside of a magnet 430.

In the description above, closures are presented using at least two or more permanent magnets. It should be understood that one of these permanent magnets can be replaced by an object of similar shape but made of a magnetizable material instead. The object made of magnetizable material will behave like a magnet when placed adjacent to the other magnet as well known in the art.

The present invention provides a closure that can be used for securing ties or cuff links. However, it could be used for fastening or securing other types of clothing or to replace other decorative or functional accessories, such as lapel pins.

The present invention may be embodied in other specific forms without departing from the spirit or essential attributes of the invention. Accordingly, reference should be made to the appended claims, rather than the foregoing specification, as indicating the scope of the invention.

I claim:

1. A clasp for securing two sections of a garment together, comprising:
a first magnet; a second magnet; and a third magnet;
a first chain attached to said first magnet and securing said first magnet to a garment;
said magnets cooperating to generate to press nips selectively engaging said two sections.

2. The clasp of claim 1, wherein at least one of said first magnet and said second magnet comprises a decorative surface.

3. The clasp of claim 1, wherein said clasp is a tie clasp.

4. The clasp of claim 1 wherein said clasp is a cuff link.

5. A clasp comprising:
a first magnet; a second magnet and a third magnet cooperating when aligned to define to pressure nips securing sections of garment.

6. The clasp of claim 5 further comprising:
a first chain attached to said first magnet and a securing said magnet selectively to said first section; and an attachment assembly.

7. The clasp of claim 6 further comprising a second chain connecting said first and said third magnets.

8. The clasp of claim 5 wherein one of said magnets has a toroidal shaped to accept a precious stone.

9. The clasp of claim 5 wherein at least one of said magnets is made with a transversal hole adapted to receive a mounting rod whereby the rod is rotatable about its axis.

10. The clasp of claim 5 wherein one of said magnets is a permanent magnet and the other of the magnets is made of a magnetizable material.
